(19) United States
(12) Patent Application Publication
(10) Pub. No.: US 2016/0143082 A1
(43) Pub. Date: May 19, 2016

(54) METHOD FOR DETECTING A MESSAGE FROM A GROUP OF PACKETS TRANSMITTED IN A CONNECTION

(71) Applicant: FUJITSU LIMITED, Kawasaki-shi (JP)

(72) Inventor: Hirokazu IWAKURA, Adachi (JP)

(73) Assignee: FUJITSU LIMITED, Kawasaki-shi (JP)

(21) Appl. No.: 14/861,236

(22) Filed: Sep. 22, 2015

(30) Foreign Application Priority Data
Nov. 13, 2014 (JP) 2014-230577

(51) Int. Cl. H04W 76/04; H04W 24/02

(52) U.S. Cl. CPC H04W 76/04; H04W 24/02

(57) ABSTRACT

A group of packets are extracted based on data captured from packets transmitted between communication apparatuses, where each packet has an identical transmission source address or an identical transmission destination address, and is transmitted in an identical connection. First and second beginning-packet candidates, which are transmitted within the identical connection, are identified based on a time difference of capturing individual packets included in the group of packets. A message length is calculated from lengths of packets including the first beginning packet candidate, captured before capturing the second beginning-packet candidate and after capturing the first beginning-packet candidate. A position, at which a message length of a message formed by the group of packets is stored, is estimated from the first beginning-packet candidate, based on the calculated message length, and the message formed by the group of packets is detected in accordance with the message length stored at the estimated position.

### CROSS-REFERENCE TO RELATED APPLICATION

This application is based upon and claims the benefit of priority of the prior Japanese Patent Application No. 2014-230577, filed on Nov. 13, 2014, the entire contents of which are incorporated herein by reference.

### FIELD

The embodiments discussed herein are related to a method for detecting a message from a group of packets transmitted in a connection.

### BACKGROUND

Analyzers are provided in order to capture communication packets flowing through a communication network that connects information processing apparatuses included in an information system, and to analyze a system state from the communication packets. An analyzer is able to reconstruct a message from received packets, and to analyze the contents (for example, a request, a response, a command, and the like) of the reconstructed message. Further, the analyzer is able to receive communication packets between servers by using a mirroring function of a switch device, and to analyze the received communication packets so as to monitor a system state.

In this manner, packets flowing through a network are captured, and the accumulated packets are used for analysis, and the like. The following techniques are provided for processing such captured packets, for example.

As a first technique, the following technique is provided (for example, Japanese Laid-open Patent Publication No. 2012-100012). In an analysis processing apparatus, a predetermined processing unit receives packets transmitted and received among computers, and measures the reception intervals of the received packets. The analysis processing apparatus detects a pair of packets. One of the packets includes a segment corresponding to the beginning of the message, and the other packets include a segment corresponding to the second or subsequent packets in accordance with the measured reception interval. The analysis processing apparatus distributes the detected packets for each pair to any one of each of a plurality of processing units, and causes the processing unit to which a packet is distributed to perform message analysis processing based on the packet distributed for each message.

As a second technique, the following technique is provided (for example, Japanese Laid-open Patent Publication No. 2004-356983). In the technique, a user box 1 configured to transmit real-time information communicated by the received telephone service to an IP network through RTP packets, and a packet information identification apparatus 2 connected to the IP network and capable of monitoring RTP packets are included. The user box continuously captures packets of a communication session of an IP stream being received from another user box of a communication destination and obtains the application identification information in the header information of the RTP packets for each of the IP streams. The user box has a mechanism for changing the jitter buffer size of an RTP packet assembly unit in the user box and the buffer control algorithm based on this.

### SUMMARY

According to an aspect of the invention, a group of packets, each of which has an identical transmission source address or an identical transmission destination address and is transmitted in an identical connection, are extracted based on data captured from packets transmitted between communication apparatuses. A first beginning-packet candidate and a second beginning-packet candidate, which are transmitted within the identical connection, are identified based on a time difference of timings of capturing individual packets included in the extracted group of packets, and a message length is calculated from packet lengths of packets including the first beginning packet candidate, captured before capturing the second beginning-packet candidate and after capturing the first beginning-packet candidate. A position at which a message length of a message formed by the group of packets is stored is estimated from the first beginning-packet candidate, based on the calculated message length, and the message formed by the extracted group of packets is detected in accordance with the message length stored at the estimated position.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of transmission intervals of communication packets;

FIG. 2 is a diagram illustrating an example of distributions of the number of packets with respect to a transmission interval when packet transmission intervals overlap;

FIG. 3 is a diagram illustrating an example of storage positions of message lengths in a packet;

FIGS. 4A and 4B are diagrams illustrating an example of a storage position of a message length in a message for each protocol type;

FIG. 5 is a diagram illustrating an example of message in which the same value as the message length is stored a plurality of times;

FIG. 6 is a diagram illustrating an example of a functional configuration of an analyzer, according to an embodiment;

FIG. 7 is a diagram illustrating an example of an information system and an analyzer, according to an embodiment;

FIG. 8 is a diagram illustrating an example of an operational sequence for an analyzer, according to an embodiment;

FIG. 9 is a diagram illustrating an example of a hardware configuration of an analyzer, according to an embodiment;

FIG. 10 is a diagram illustrating an example of a connection information table, according to an embodiment;

FIG. 11 is a diagram illustrating an example of a packet management table, according to an embodiment;

FIG. 12 is a diagram illustrating an example of a message position definition table, according to an embodiment;

FIG. 13 is a diagram illustrating an example of a distribution table, according to an embodiment;

FIG. 14 is a diagram illustrating an example of a storage position detection frequency table, according to an embodiment;

FIG. 15 is a diagram illustrating an example of a data structure of a packet;

FIG. 16 is a diagram illustrating an example of a structure of an IP header;

FIG. 17 is a diagram illustrating an example of a structure of a TCP header;

FIG. 18 is a diagram illustrating an example of a TCP connection sequence;

FIG. 19 is a diagram illustrating an example of an operational flowchart for packet distribution for each message, according to an embodiment;

FIG. 20 is a diagram illustrating an example of an operational flowchart for packet distribution processing of each message, according to an embodiment;

FIG. 21 is a diagram illustrating an example of an operational flowchart for protocol record and distribution processing of immediately preceding message, according to an embodiment; and

FIG. 22 is a diagram illustrating an example of an operational flowchart for distribution processing of a packet having a recorded protocol, according to an embodiment.

### DESCRIPTION OF EMBODIMENTS

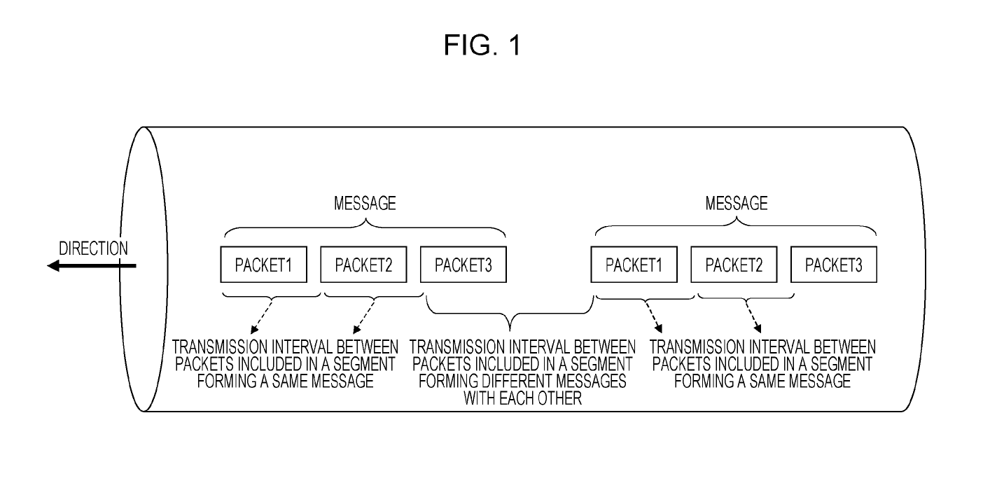

In the first technique, packets are distributed for each message based on the characteristic that packet transmission intervals differ between the packets forming the same message and the packets forming a different message. A description will be given of this using FIG. 1.

FIG. 1 is an explanatory diagram of transmission intervals of communication packets. There are two kinds of packet transmission intervals, that is to say, a packet transmission interval within the same message, and a packet transmission interval between different messages. The packet transmission interval within the same message is shorter than the packet transmission interval between different messages. The reason for this arises from the fact that a server application program makes a transmission request to a kernel of an operating system (OS) for each message in relation to message transmission processing of a server. Accordingly, a packet transmission interval between packets within the same message, which are produced by dividing a message into packets in the kernel, decreases. On the other hand, transmission requests of two different messages, which are divided by a server application program, are separately made to the kernel sequentially, and thus a packet transmission interval between different messages increases.

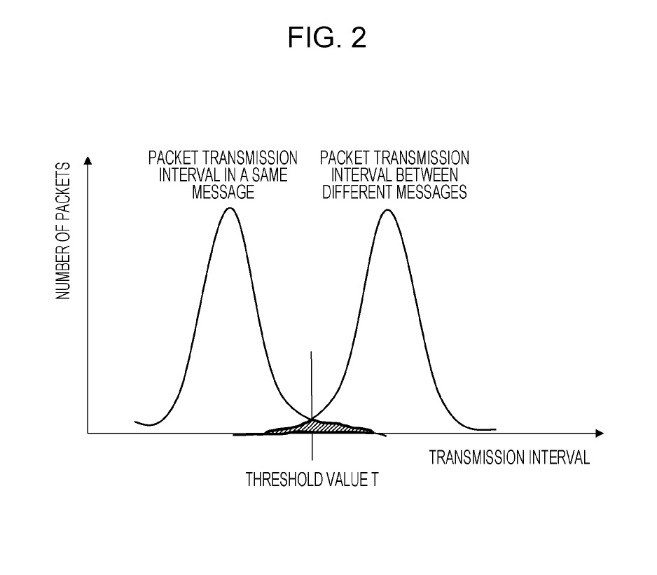

Incidentally, an increase in speed of message transmission processing is expected thanks to the performance improvement of information systems, application programs, and the like, and changes in the packet transmission procedure, and the like. From such a viewpoint, there is a possibility that a time lag decreases between the transmission intervals of packet transmission within the same message and packet transmission between different messages, depending on an environment of message transmission processing. As a result, it might be difficult to identify each message with high precision in accordance with a packet transmission interval in the same connection. A description will be given of this using FIG. 2.

FIG. 2 illustrates distributions of the number of packets with respect to a transmission interval when packet transmission intervals overlap. The following processing is performed when packets forming each message are identified from a transmission interval of the packets, and a message length is obtained from the sum of packet lengths. That is to say, from a distribution of packet transmission intervals in the same message and a distribution of packet transmission intervals between different messages, a threshold value of a packet transmission interval is determined in order to determine to which distribution a packet belongs. Regarding the relationship between the two distributions, there are two cases, that is to say, depending on the sizes of the variances of the distributions, there is a case in which parts of the distributions overlap, and a case in which there is no overlap. In the case where parts of the distributions overlap, it is assumed that a packet transmission interval at which the distributions of the two groups intersect is a threshold value T.

However, when a packet transmission interval of different messages is smaller than the threshold value T, or when a packet transmission interval in the same message is larger than the threshold value T, it is difficult to correctly determine which distribution a packet belongs to.

On the other hand, although information indicating a message length is included at a predetermined position in the beginning packet of a message, when the predetermined position is unknown, it is difficult to correctly determine the packet group for each message.

According to an embodiment of the present disclosure, it is desirable to provide a technique for improving the detection precision of packets for each message.

When an analyzer receives a communication packet in order to analyze a system state, the analyzer collects connection information (connection destination IP address, connection destination port number, connection source IP address, and connection source port number) from the received packet. Then an analyzer 1 monitors the transmission interval of packets for each connection so as to summarize a packet group forming one message, to detect the packet group as a message, and to execute message analysis processing. At this time, as described above, there is a problem with the classification precision of packets when using only the transmission interval of the packets.

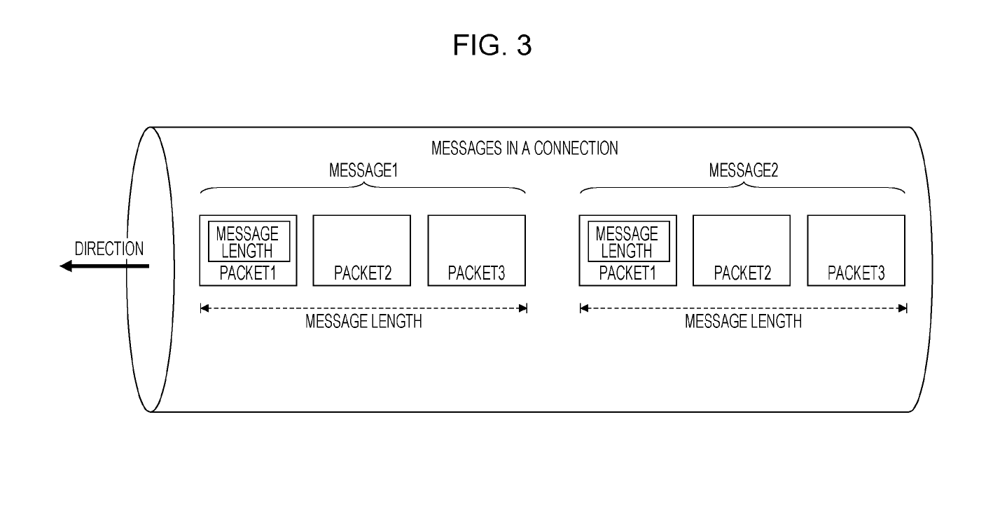

Thus, in the present embodiment, packet classification precision is improved further by using the message length in addition to the transmission interval of packets. The message length is held by the individual message itself. A description will be given of this by using FIG. 3.

FIG. 3 is an explanatory diagram of storage positions of message length in a packet. The message length is stored in any one or more packets that form a message, and is often stored in the beginning packet. In this regard, hereinafter a range from the beginning packet to the end packet in the same message is sometimes referred to as a packet range that forms the same message.

One message is formed by one or a plurality of packets. Thus, it is thought that an analyzer reads message lengths in captured packets, and combines the captured packets until the total length reaches the read message length so as to generate one message.

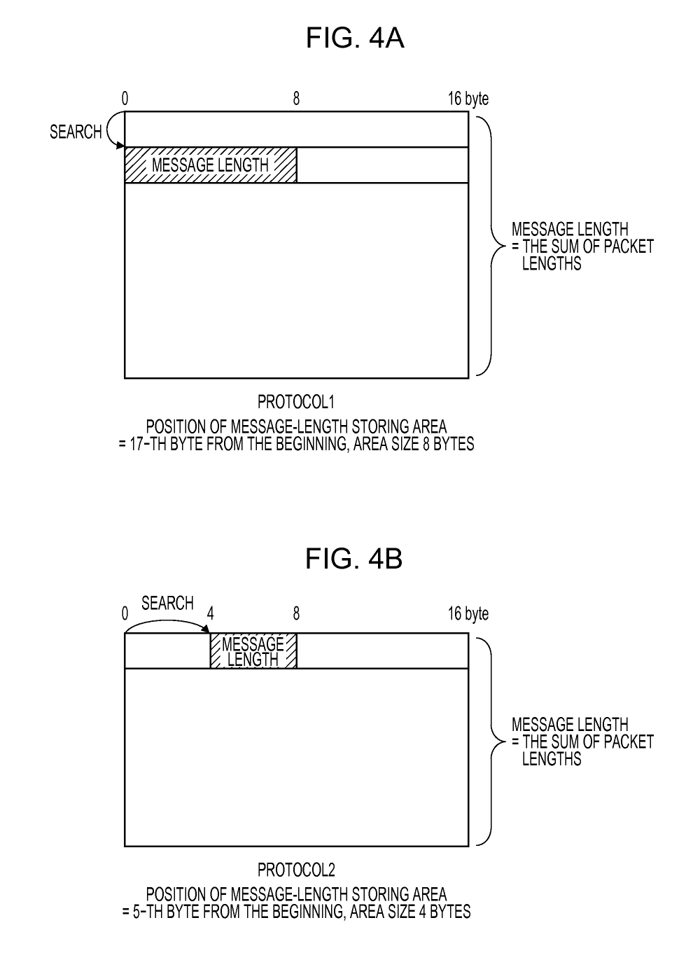

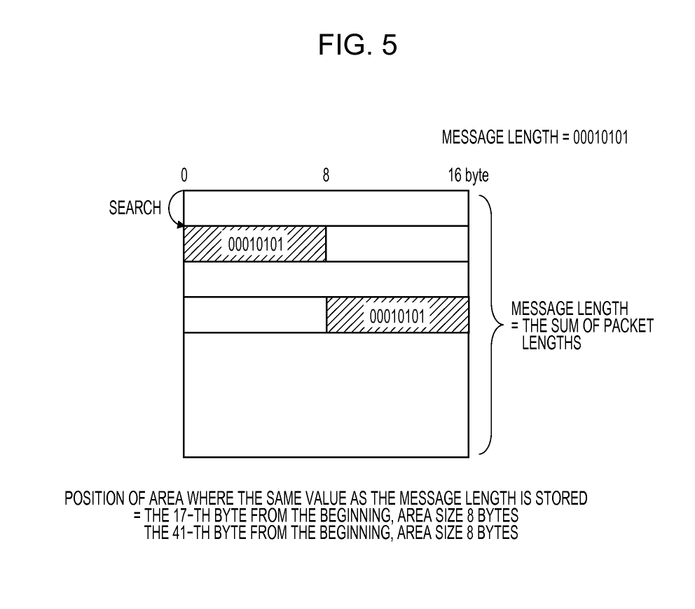

However, it is not possible to easily identify the storage position of a message length as illustrated in FIGS. 4A and 4B, and FIG. 5.

The position of message length storing area differs depending on a communication protocol as illustrated in FIGS. 4A and 4B. Accordingly, when determination of the communication protocol used in the received packet fails, it is not possible to identify the position of message length storing area.

FIGS. 4A and 4B are explanatory diagrams of the storage position of a message length in a message. FIG. 4A illustrates an example of a message of protocol 1, in which the storage position of the message length is the 17th byte from the beginning of the message formed by a combination of packets, and the storage area size is 8 bytes. FIG. 4B illustrates an example of a message of protocol 2, in which the storage position of the message length is the 5th byte from the beginning of the message, and the storage area size is 4 bytes.

As illustrated in FIG. 4A and FIG. 4B, the position of message length storing area differs depending on communication protocol. Accordingly, when determination of the communication protocol used in the received packet fails, it is not possible to identify the position of message length storing area.

Thus, the message length of a group of packets forming one message, which are extracted using the transmission interval of the packets, is measured, and the entire message is searched for the message length so that it is possible to obtain the storage position of the message length. Then regarding packets captured subsequently, it is thought that the message length is obtained based on the obtained storage position of the message length and each message is detected by extracting one message by using the message length.

On the other hand, as illustrated in FIG. 5, in some messages, the same value as the message length is sometimes stored at a plurality of locations, and thus when a protocol is unknown, it is difficult to determine at which position the value indicating the message length is stored.

Thus, an analyzer according to the embodiment obtains a group of packets estimated to form one message, based on the transmission interval of packets, measures the message length of the group of packets, and further carries out the following. That is to say, the analyzer measures, for each message, the number of times of detection of each position at which the same value as the message length is stored, and estimates that the position having a high frequency of the number of times of detection is the storage position (estimated storage position) of the message length. The analyzer stores received packets in a buffer until the sum of the received packets in sequence reaches the message length obtained from the estimated storage position. When the sum total of the packet lengths of the packet group stored in the buffer reaches the message length obtained from the estimated storage position, the analyzer determines a group of packets stored in the buffer as one message and distributes the group of packets to message analysis processing.

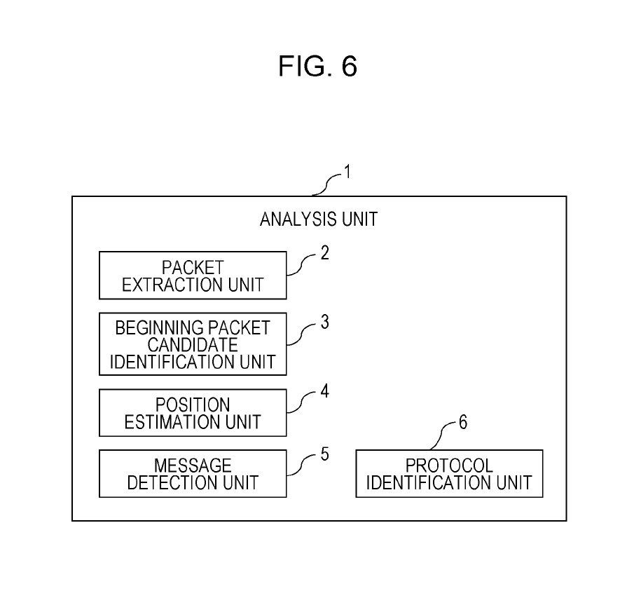

FIG. 6 illustrates a block diagram of an analyzer according to the embodiment. The analyzer 1 includes a packet extraction unit 2, a beginning packet candidate identification unit 3, a position estimation unit 4, and a message detection unit 5.

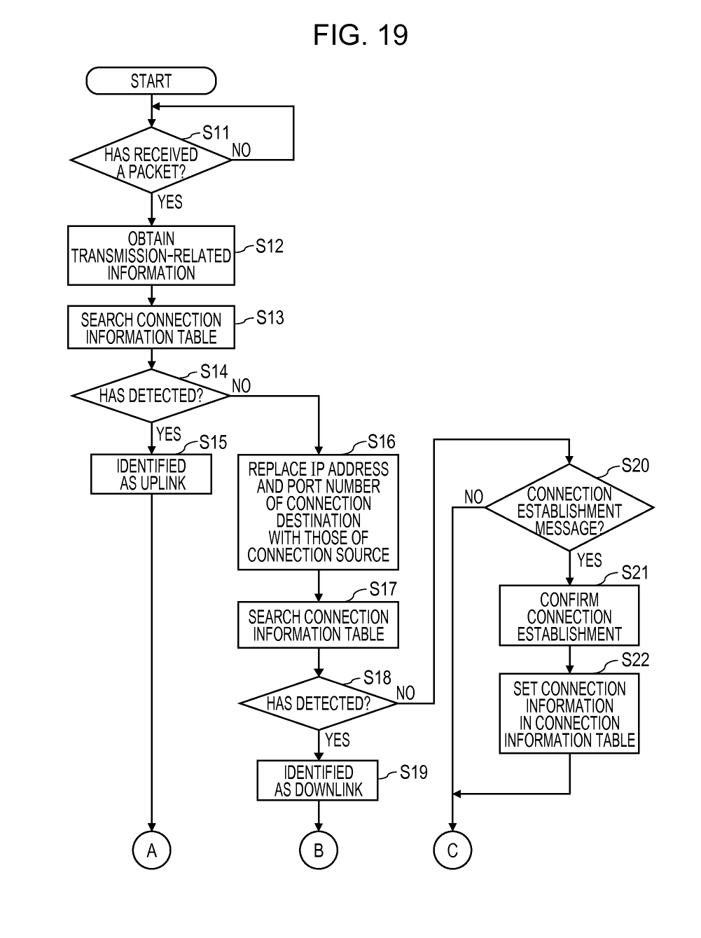

The packet extraction unit 2 extracts a group of packets that have the same transmission source address or transmission destination address and are transmitted using the same connection, based on the captured data of packets transmitted between communication apparatuses. As an example of the packet extraction unit 2, a CPU 0 that performs the processing in S15 or S19 in FIG. 19 is provided.

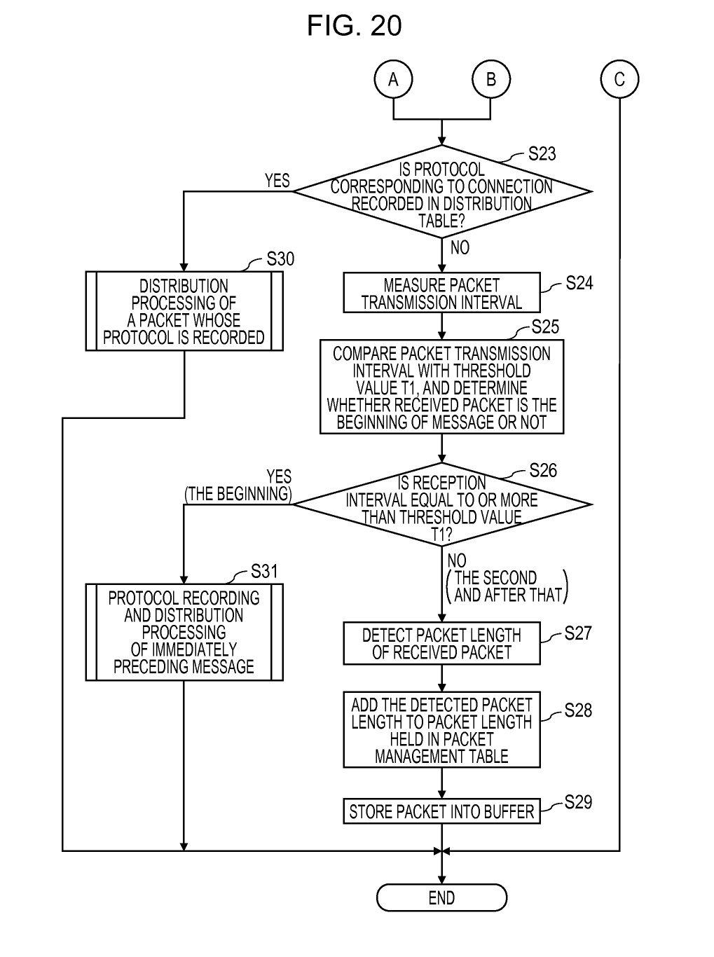

The beginning packet candidate identification unit 3 identifies the first beginning packet candidate and the second beginning packet candidate that have been transmitted using the same connection, based on the time difference of the capture timing of individual packets included in the extracted group of packets. As an example of the beginning packet candidate identification unit 3, the CPU 0 that performs the processing in S24 to S25 in FIG. 20 is provided.

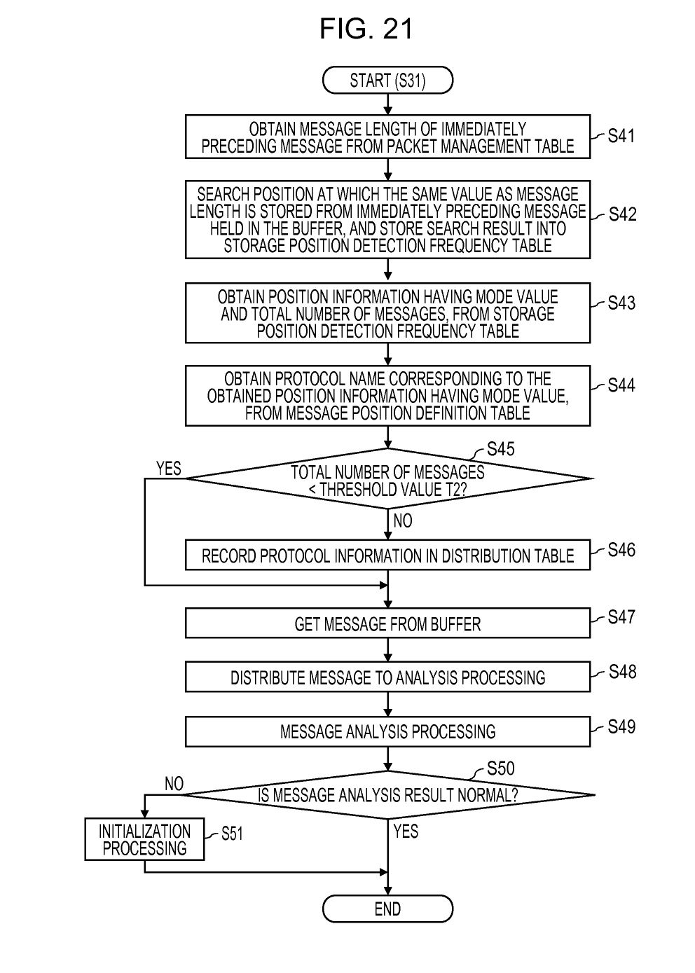

The position estimation unit 4 calculates a message length from the packet lengths of the captured group of packets. The position estimation unit 4 estimates a position at which the message length of the message formed by the group of packets is stored, from the first beginning packet candidate, based on the calculated message length. Here, the captured group of packets is a group of packets that include the first beginning packet candidate and that are captured after the first beginning packet candidate is captured and before the second beginning packet candidate is captured. As an example of the position estimation unit 4, the CPU 0 that performs the processing in S41 to S46 in FIG. 21 may be provided.

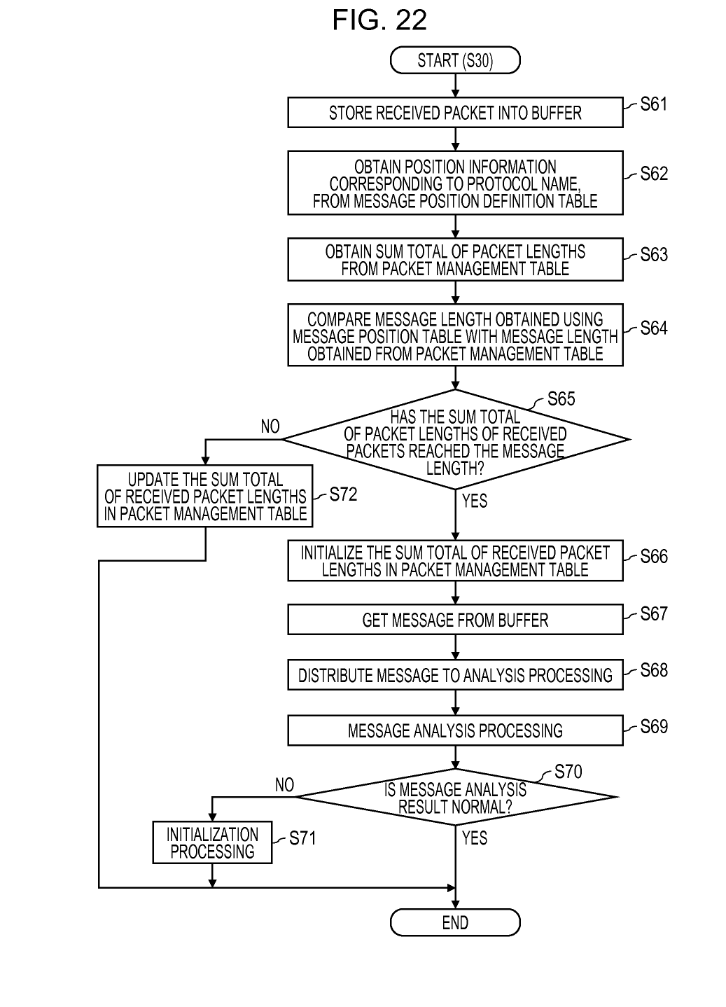

The message detection unit 5 detects a message formed by the extracted group of packets in accordance with the message length stored in the estimated position. As an example of the message detection unit 5, the CPU 0 that performs the processing in S65 in FIG. 22 may be provided.

With such a configuration, it is possible to improve the detection precision of packets of each message.

The position estimation unit 4 searches, for each message, a group of packets including a first beginning packet candidate for a position at which the same value as the message length is stored, and measures the number of times of position detection for each position. The position estimation unit 4 estimates that the position having the largest number of times of measurement is the position at which the message length of the message formed by the group of packets is stored.

With such a configuration, it is possible to estimate a position at which the message length of a message is stored based on the received group of packets.

The message detection unit 5 obtains the message length from the received packets based on the estimated position and holds the received packets in sequence. When the sum total of the packet lengths of the held packets reaches the message length, the message detection unit 5 determines that the held group of packets is one message.

With such a configuration, it is possible to detect one message with high precision.

The analyzer 1 further includes a protocol identification unit 6. When the position is estimated, the protocol identification unit 6 obtains a communication protocol corresponding to the estimated position, from the information in which the communication protocol is associated with the message storage position. The protocol identification unit 6 identifies that the communication protocol corresponding to the message connection is the obtained communication protocol.

In this case, when the message detection unit 5 has received packets and identified the communication protocol of the connection information of the received packets, the message detection unit 5 obtains the message length from the received packets, based on the estimated position, and holds the received packets in sequence. When the sum total of the packet lengths of the held packets reaches the message length, the message detection unit 5 determines that the held group of packets is one message.

With such a configuration, when the communication protocol of the connection information of the received packets is identified, it is possible to identify one message from the received packets not by using the message interval, but by using the message length.

In the following, a detailed description will be given of an embodiment for implementing the present disclosure.

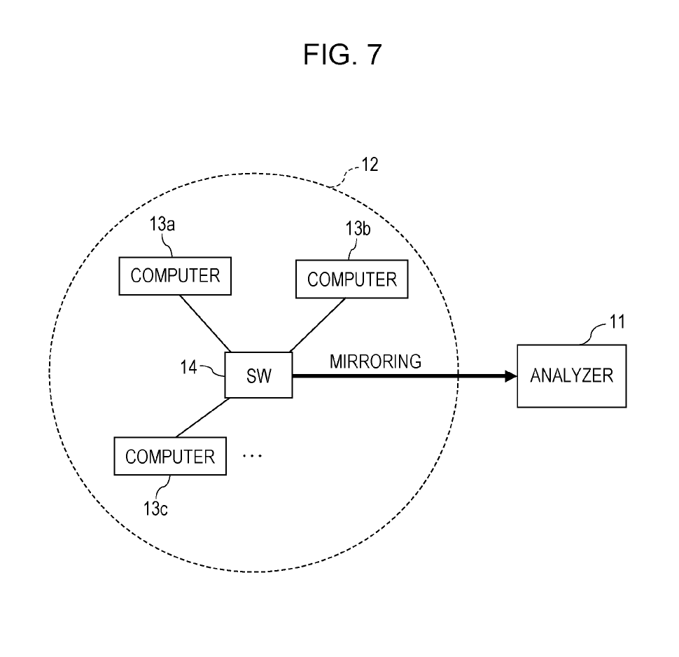

FIG. 7 illustrates an information system and an analyzer according to the embodiment. An information system 12 includes a plurality of computers 13 (13a, 13b, 13c, . . . ) and a switch device (SW) 14.

An analyzer 11 receives packets that are exchanged by the computers 13 (13a, 13b, 13c, . . . ) with one another, by using the mirroring function of the SW 14, and monitors and analyzes the operation states of the computers, based on the received packets. That is to say, the analyzer 11 reconstructs a message from the received packets and monitors messages indicating a request and messages indicating a response. Thereby, it is possible for the analyzer 11 to monitor and analyze the operation state, the communication state, and the like of the computers communicating with each other.

The SW 14 is a relay device performing switching of packet transmission lines, such as a local area network (LAN) switch (SW), or the like, for example. The computers 13a, 13b, 13c, . . . and the like are connected to the SW 14.

The SW 14 is capable of transmitting and receiving packets with the computers 13 or a relay device not illustrated in FIG. 7. The SW 14 is provided with a plurality of communication ports. When a packet enters in one of the communication ports, the SW 14 selects a suitable communication port as a packet transmission destination and transmits the packet from the selected communication port. In the embodiment, the computers 13 (13a, 13b, 13c, . . . ) are respectively connected to these communication ports. The SW 14 includes a circuit for achieving the port mirroring function. The port mirroring function is a function for replicating packets that pass through a specific communication port and for transmitting the replicated packets from a mirrored port. In the embodiment, the SW 14 is provided with one mirrored port. The port mirroring function replicates all the packets entering two or more communication ports and outputs the replicated packets from the mirrored port. In the embodiment, an analyzer 11 is connected to the mirrored port of the SW 14. In this regard, replication source packets (original packets) are respectively transmitted from suitable communication ports.

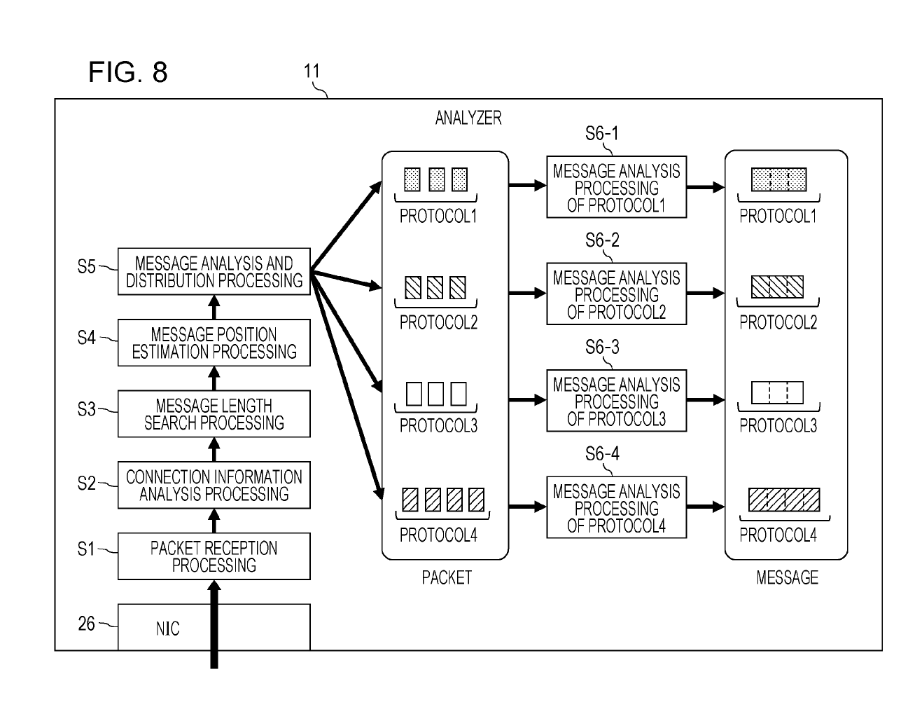

FIG. 8 illustrates a processing sequence of the analyzer according to the embodiment. The analyzer 11 receives through a network interface card (NIC) 26 (51) communication packets which have been transferred among the computers 13 and transferred from the SW 14.

The analyzer 11 obtains connection information (connection destination IP address, connection destination port number, connection source IP address, and connection source port number) from the header information (IP header and TCP header) of the received packet, and performs analysis processing on the connection information. In the analysis processing of the connection information, the analyzer 11 identifies a connection corresponding to the packet, based on the obtained connection information, identifies the connection direction, and identifies the packet transmission direction (S2). Here, when connection establishment is requested by a client for a server, a connection is made using a connection destination IP address and a connection destination port number, and thus a protocol type is determined according to the combination of the connection destination IP address and the connection destination port number.

Next, the analyzer 11 detects a group of packets forming one message, based on the transmission interval of the received packets, and calculates the sum of the packet lengths of the detected group of packets as a message length (S3). In this regard, in the embodiment, the reception interval determined by the analyzer 11 is detected as the packet transmission interval.

The analyzer 11 estimates the position at which the message length is stored from the message formed by the detected packet group by using the message length obtained in S3 (S4). Here, the analyzer 11 searches for positions at which the same value as the value of the message length obtained in S3 is stored for each message formed by the detected packet group, and measures the number of times of detection for each of the positions. The analyzer 11 performs the processing in S1 to S4 for a predetermined number of messages, and estimates that a position having the highest number of times of detecting the same value as the value indicated by the message length is the position at which the message length is stored (the estimated storage position).

The analyzer 11 obtains the protocol type corresponding to the estimated storage position from the recorded data of the storage position information of the message length for each protocol type (message position definition table).

The analyzer 11 associates the connection destination IP address and the connection destination port number with the obtained protocol type, and records these items in a distribution table in order to distribute message analysis processing to each protocol.

Next, when a packet having the connection destination IP address and the connection destination port number that are recorded in the distribution table is received, that is to say, when the protocol to be used by the received packets is recorded in the distribution table, the analyzer 11 performs the following processing. The analyzer 11 identifies one message from the received packets not by using the message interval, but by using the message length.

In this case, the analyzer 11 stores the received packets in the buffer. The analyzer 11 identifies a protocol type corresponding to the combination of the connection destination IP address and the connection destination port number from the distribution table. Further, the analyzer 11 obtains a storage position of the message length corresponding to the identified protocol type from the message position definition table.

The analyzer 11 obtains a message length from the received packets based on the obtained storage position of the obtained message length. The analyzer 11 holds the received packets in the buffer until the sum of the packet lengths of the packets stored in the buffer reaches the obtained message length.

When the sum of the packet lengths of the packets stored in the buffer reaches the obtained message length, the analyzer 11 distributes the group of packets held in the buffer as one message to message analysis processing corresponding to the identified protocol (S5). The analyzer 11 performs analysis processing on the message distributed to each protocol (S6-1 to S6-4).

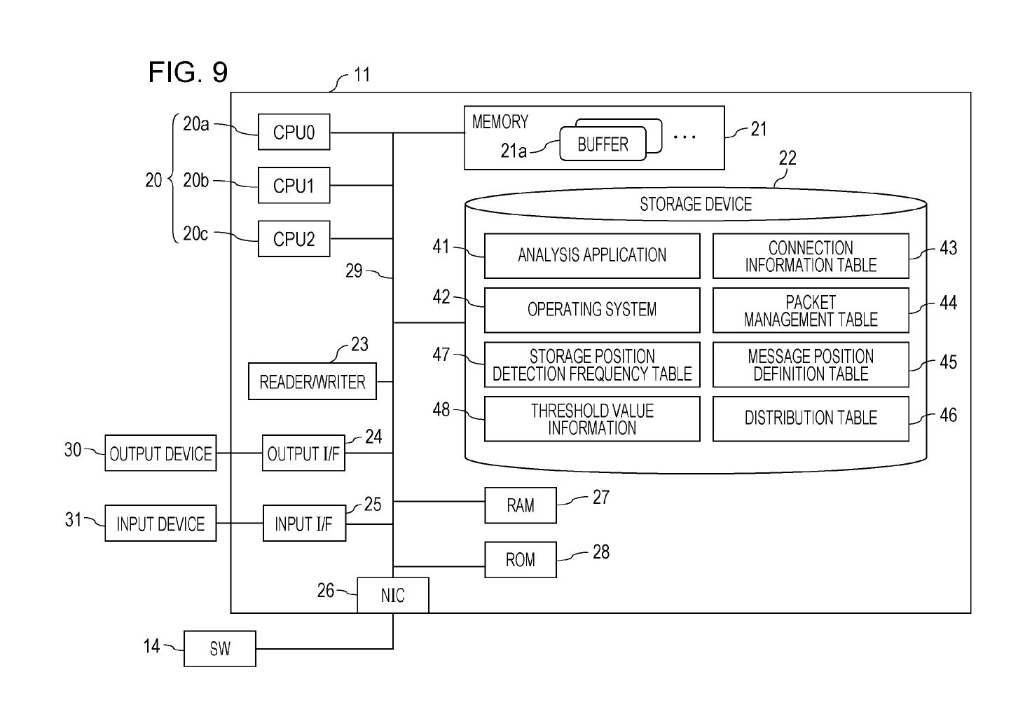

FIG. 9 illustrates a hardware configuration diagram of the analyzer according to the embodiment. The analyzer 11 is a computer including a multiprocessor 20, a memory 21, a storage device 22, a reader/writer 23, an output I/F 24, an input I/F 25, a NIC 26, a RAM 27, a ROM 28, a bus 29, and the like, for example. ROM denotes read only memory. RAM denotes random access memory. I/F denotes interface. The multiprocessor 20, the memory 21, the storage device 22, the reader/writer 23, the output I/F 24, the input I/F 25, the NIC 26, the RAM 27, the ROM 28, and the like are connected through the bus 29.

The multiprocessor 20 includes a CPU 0 (20a), a CPU 1 (20b), and a CPU 2 (20c). In this regard, the multiprocessor according to the embodiment includes three CPUs. However, the present disclosure is not limited to this and ought to include two CPUs or more. The CPU 0 (20a), the CPU 1 (20b), and the CPU 2 (20c) may include a timer function for measuring time, or a counter function for measuring a time period. Also, the analyzer 11 may include a clock circuit separate from the CPU 0 (20a), the CPU 1 (20b), and the CPU 2 (20c). In this case, each CPU may obtain time information or count information obtained by the clock circuit.

The memory 21 includes a buffer 21a. The buffer 21a is a buffer used by each CPU, for example.

The storage device 22 stores an operating system (OS) 42, and an analysis application program 41. Further, the storage device 22 stores a connection information table 43, a packet management table 44, a message position definition table 45, a distribution table 46, a storage position detection frequency table 47, threshold value information 48, and the like. At the time of starting the analyzer 11, the multiprocessor 20 reads the OS 42 and the analysis application program 41 from the storage device 22, loads them into the memory 21, and executes the individual programs. In this regard, it is possible to use various types of storage devices, such as a hard disk, a flash memory device, and the like as a storage device 22. The analysis application program 41 includes a packet analysis program according to the embodiment. The threshold value information 48 stores threshold values used in the embodiment.

The NIC 26 is connected to the mirrored port of the SW 14. By the mirroring function of the SW 14, packets generated for the communication among the computers 13 to be monitored are transmitted from the SW 14 to the NIC 26. A packet that has reached the NIC 26 reaches the analysis application program 41 through the operating system 42 by using a promiscuous mode of the NIC 26, and is captured by the analysis application program 41. Here, the promiscuous mode is a mode of receiving not only packets having a destination of itself, but also packets having other destinations.

The reader/writer 23 is a device that reads information from a portable recording medium, or writes information into the portable recording medium. The output device 30 is connected to the output I/F 24. The input device 31 is connected to the input I/F 25.

The analysis application program 41 may be provided from a program provider through a communication network and a NIC16, and may be stored into the storage device 22, for example. Also, the analysis application program 41 may be stored into a portable recording medium marketed and distributed. In this case, the portable recording medium may be set in the reader/writer 23, and the program of the portable recording medium may be read and executed by the multiprocessor 20. For the portable recording medium, it is possible to use various types of recording media, such as a CD-ROM, a flexible disk, an optical disc, a magneto-optical disc, an IC card, a USB memory device, a DVD, and the like.

Also, for the input device 31, it is possible to use a keyboard, a mouse, an electronic camera, a Web camera, a microphone, a scanner, a sensor, a tablet, and the like. Also, for the output device 30, it is possible to use a display, a printer, a speaker, and the like. Also, the network may be a communication network, such as the Internet, a LAN, a WAN, a dedicated line, and a wired or wireless communication line.

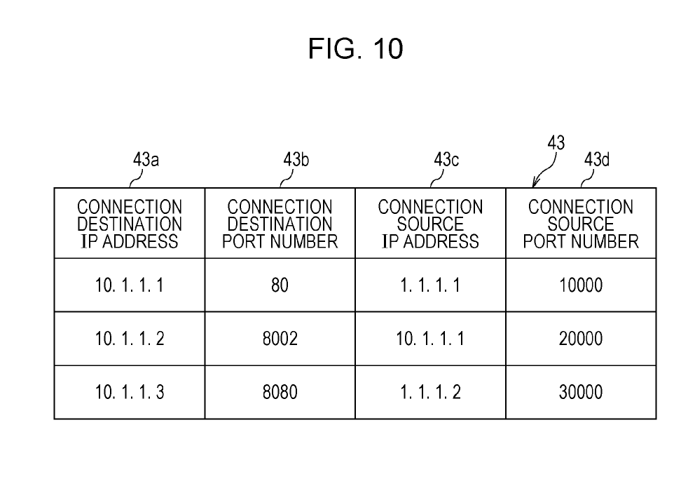

FIG. 10 illustrates an example of a connection information table according to the embodiment. The connection information table 43 includes data items, such as “connection destination IP address” 43a, “connection destination port number” 43b, “connection source IP address” 43c, and “connection source port number” 43d.

The IP address of a connection destination is stored in “connection destination IP address” 43a. The port number of the connection destination is stored in “connection destination port number” 43b. The IP address of a connection source is stored in “connection source IP address” 43c. The port number of the connection source is stored in “connection source port number” 43d. Here, the “connection source” is a side that has requested a connection at the time of establishing the connection. The “connection destination” is a side to which a connection has been requested at the time of establishing the connection. Descriptions will be given later of the “connection source”, and the “connection destination”.

In the following, a set of information including “connection destination IP address”, “connection destination port number”, “connection source IP address”, and “connection source port number” is referred to as a connection information.

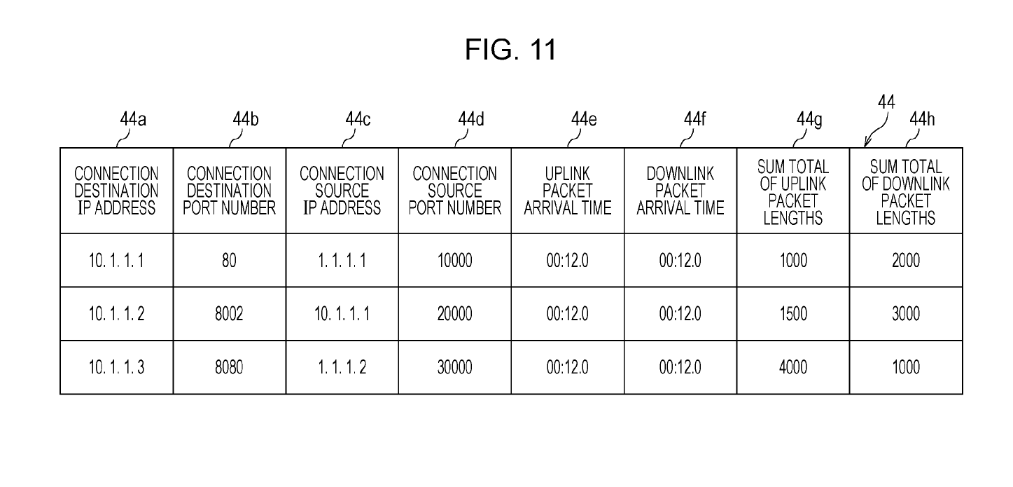

FIG. 11 illustrates an example of the packet management table according to the embodiment. The packet management table 44 includes data items of “connection destination IP address” 44a, “connection destination port number” 44b, “connection source IP address” 44c, “connection source port number” 44d, “uplink packet arrival time” 44e, and “downlink packet arrival time” 44f. The packet management table 44 further includes data items of “sum total of uplink packet lengths” 44g, and “sum total of downlink packet lengths” 44h.

The “connection destination IP address” 44a stores the IP address of the connection destination. The “connection destination port number” 44b stores the port number of the connection destination. The “connection source IP address” 44c stores the IP address of the connection source. The “connection source port number” 44d stores the port number of the connection source. The “uplink packet arrival time” 44e stores the arrival time (reception time) of a packet whose connection direction is uplink. The “downlink packet arrival time” 44f stores the arrival time (reception time) of a packet whose connection direction is downlink. The “sum total of uplink packet lengths” 44g stores the sum total of the packet lengths of packets whose connection direction is uplink. The “sum total of downlink packet lengths” 44h stores the sum total of the packet lengths of packets whose connection direction is downlink.

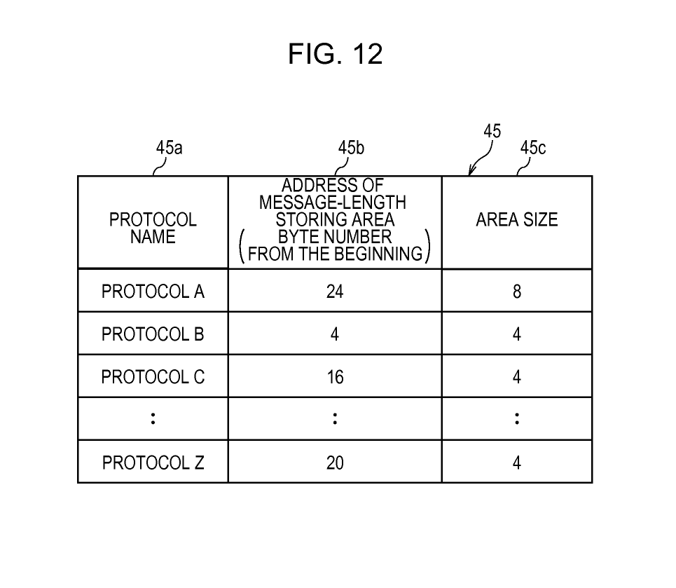

FIG. 12 illustrates an example of a message position definition table according to the embodiment. The message position definition table 45 includes data items of “protocol name” 45a, “address of message length storing area” 45b, and “size of message-length storing area” 45c. The “protocol name” 45a stores the name of a communication protocol. The “address of message-length storing area” 45b stores the address of an area in which the message length is stored, which is expressed by the number of bytes from the beginning of a packet, in the case of the communication protocol identified by the “protocol name” 45a. The “size of message-length storing area” 45c stores the size of an area storing the message length for the communication protocol.

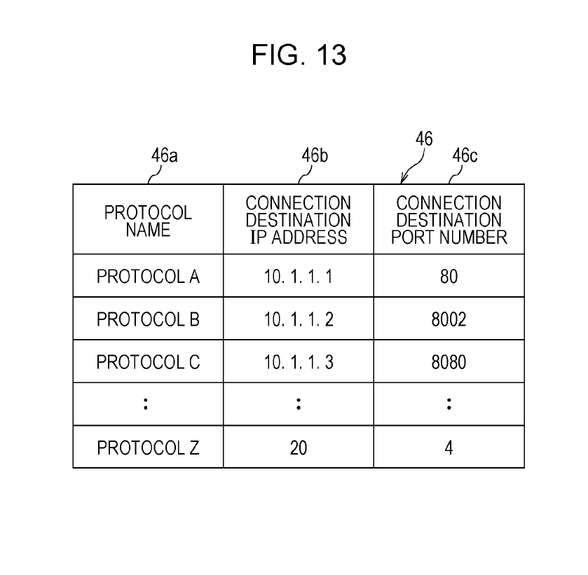

FIG. 13 illustrates an example of a distribution table according to the embodiment. The distribution table 46 includes data items of “protocol name” 46a, “connection destination IP address” 46b, and “connection destination port number” 46c.

The “connection destination IP address” 46b stores the IP address of a connection destination. The “connection destination port number” 46c stores the port number of the connection destination. The “protocol name” 46a stores the name of a communication protocol used in a connection identified by the “connection destination IP address” 46b and the “connection destination port number” 46c.

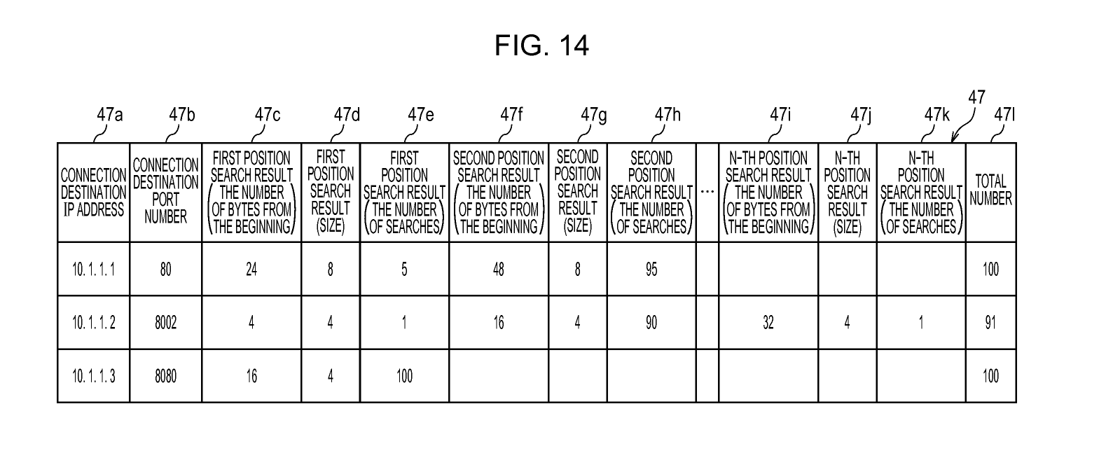

FIG. 14 illustrates an example of a storage position detection frequency table according to the embodiment. The storage position detection frequency table 47 includes data items of “connection destination IP address” 47a, “connection destination port number” 47b, detection results (47c to 47k) of packets in the same connection, and “total number” 47I. The detection results of packets in the same connection are “the number of bytes from the beginning (to the position)”, “size”, and “the number of times of detection (at the position)”, which are obtained as a search result of each packet from the first position to the n-th position.

The “number of bytes from the beginning (to the position)” indicates the position at which the same value as the message length obtained in S3 is stored, and indicates the byte address from the beginning of a packet. The “size” indicates the size of an area in which the message length obtained in S3 is stored. The “number of times of detection (of the position)” indicates the number of times of detection of the position. The “total number” I indicates the total number of the processed messages.

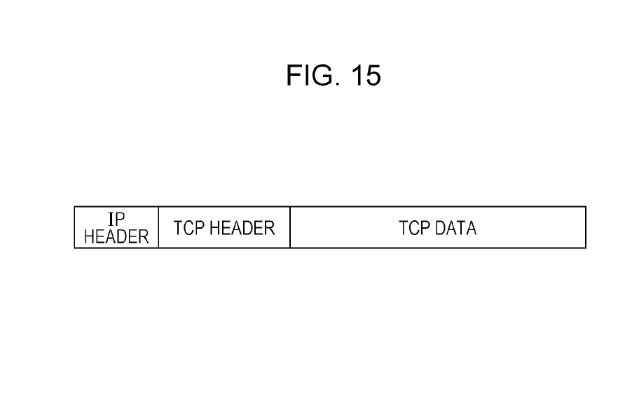

FIG. 15 illustrates a data structure of a packet. A packet includes an IP header, a TCP header, and TCP data.

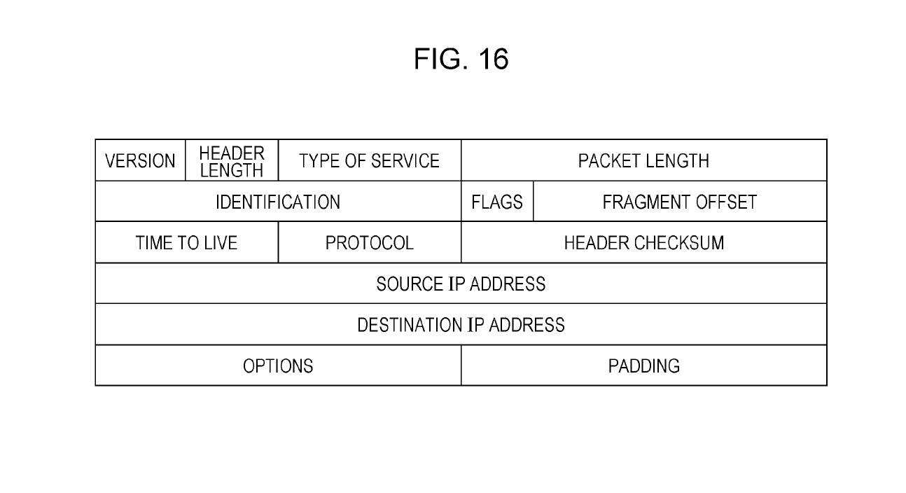

FIG. 16 illustrates a structure of an IP header. The IP header includes items of a version, a header length, a type of service, a packet length, an identification, a flag, a fragment offset, a time to live, a protocol, a header checksum, a transmission source IP address, a transmission destination IP address, options, and padding. A total packet size (bytes) is set in “packet length”. The IP address of a transmission source is set in “transmission source IP address”. The IP address of a transmission destination is set in “transmission destination IP address”. The items other than these are not referred to in the embodiment, and thus are omitted.

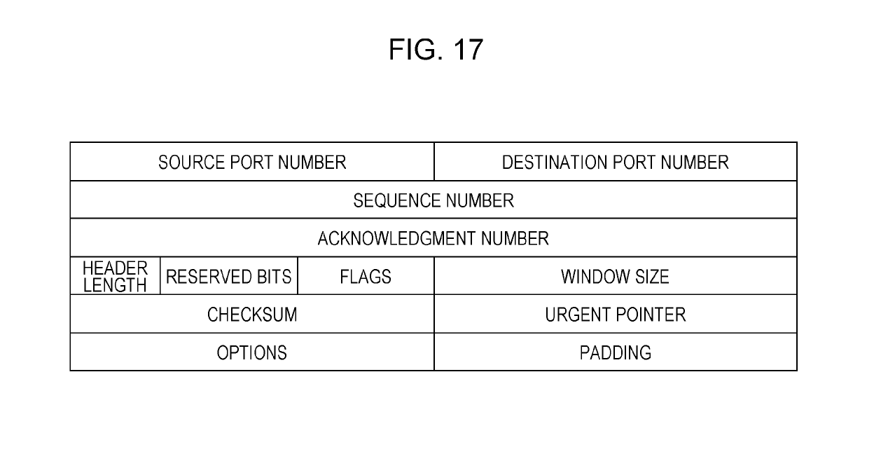

FIG. 17 illustrates a structure of a TCP header. The TCP header includes items of a transmission source port number, a transmission destination port number, a sequence number, an acknowledgment number, a header length, reserved bits, a flag, a window size, a checksum, an urgent pointer, options, and padding. The port number of a transmission source is set in “transmission source port number”. The port number of a transmission destination is set in “transmission destination port number”.

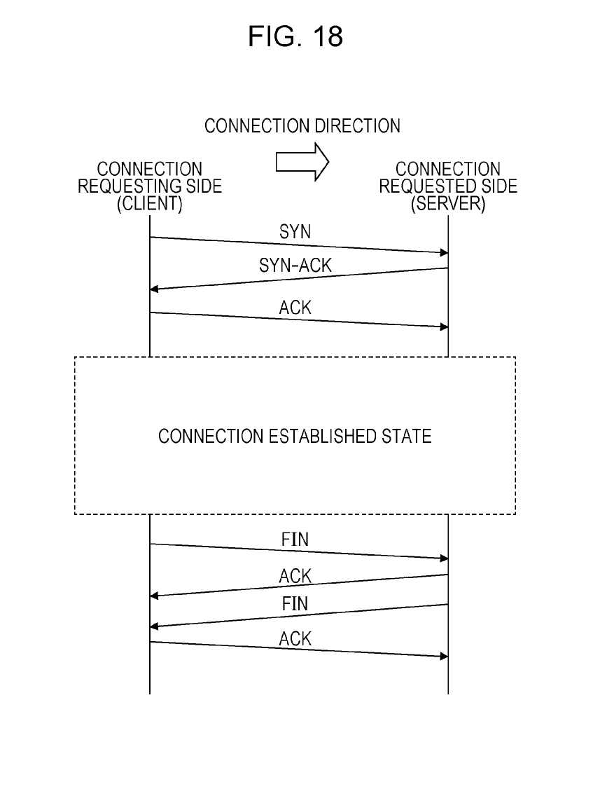

FIG. 18 illustrates an example of a TCP connection sequence. First, a description will be given of establishment of a TCP connection by a three-way handshake. A side that requests a connection (hereinafter referred to as a client) transmits a SYN packet (a packet whose flag indicating SYN in the TCP header is set at ON) to a side to which a connection is requested (hereinafter referred to as a server). A server transmits a SYN-ACK packet (a packet having the item “flag” in the TCP header in which the SYN flag and the ACK flag are set at ON) to a client. The client transmits an ACK packet (a packet whose ACK flag is set at ON) to the server. Thereby, a connection is established between a side that requests the connection (client) and a side to which the connection is requested (server).

Here, a side that requests a connection (client) is referred to as a “connection source”. A side to which a connection is requested (server) is referred to as a “connection destination”. A connection direction from the side that requests the connection (client) to the side to which a connection is requested (server) is referred to as a “uplink”, and the opposite direction is referred to as a “downlink”.

Next, a description will be given of a break of a TCP connection. A computer that attempts to break a TCP connection transmits a FIN packet (a packet having the item “flag” in the TCP header in which the FIN flag is set at ON) requesting to break the connection to the other computer. In response, the other computer transmits an ACK packet to the computer attempting to break the TCP connection, and a one-way connection is released. Further, the other computer transmits a FIN packet to the computer attempting to break the TCP connection. In response, the computer attempting to break the TCP connection transmits an ACK packet to the other computer, and the other one-way connection is also released.

FIG. 19 and FIG. 20 illustrate details of a packet distribution sequence for each message according to the embodiment. For example, it is assumed that the CPU 0 reads a packet reception program 41a from the storage device 22, and executes packet reception processing. Also, it is assumed that the CPU 1 and the CPU 2 individually read a message analysis program 41b from the storage device 12, and executes message analysis processing, for example.

The CPU 0 continually receives the packets captured by the analysis application program 41 (S11). The CPU 0 obtains “transmission source IP address”, and “transmission destination IP address” from the IP header of the received packet. Further, the CPU 0 obtains “transmission source port number”, and “transmission destination port number” from the TCP header (S12). In the following, “transmission source IP address”, “transmission destination IP address”, “transmission source port number”, and “transmission destination port number” are put together, and referred to as “transmission related information”.

The CPU 0 searches the connection information table 43 by using the transmission related information obtained in S12. Thereby, the CPU 0 detects whether a connection is established, and further detects the packet transmission direction (S13). Specifically, the CPU 0 determines whether the connection information (the “connection destination IP address”, the “connection destination port number”, the “connection source IP address”, and the “connection source port number”) matching the transmission related information obtained in S12 is recorded in the connection information table 43 or not.

Here, before a connection by a three-way handshake is established, the connection information on the connection is not recorded in the connection information table 43, and thus the processing proceeds to “No” in S14. Then the processing proceeds to S16 to S18 (“No” in S18), and the CPU 0 determines whether the received packet is a connection establishment message or not (S20). When the received packet is not a connection establishment message (“No” in S20), this processing flow terminates.

Accordingly, in the connection establishment preparation stage by the three-way handshake, when a SYN packet or a SYN-ACK packet is received (“No” in S20), this processing flow terminates.

When an ACK packet is further received after the SYN packet or the SYN-ACK packet is received, that is to say, when a connection establishment message is detected (“Yes” in S20), the CPU 0 confirms establishment of a connection (S21). In this case, the CPU 0 records the transmission-related information obtained in S12 in the connection information table 43 as the connection information (“connection destination IP address”, “connection destination port number”, “connection source IP address”, and “connection source port number”) (S22). Thereby, this processing flow terminates.

In this manner, during the connection establishment preparation stage by the three-way handshake, the processing in S11 to S13, “No” in S14, the processing in S16 to S17, “No” in S18, and the processing in S20 are repeated.

In the case of a packet received after the connection establishment, after processing in S11 and S12, the CPU 0 searches the connection information table 43 by using the transmission related information obtained in S12. Thereby, the CPU 0 determines whether a connection is established, and further detects the packet transmission direction (S13).

When the connection information matching the transmission related information obtained in S12 is recorded in the connection information table 43 (“Yes” in S14), the CPU 0 identifies the received packet transmission direction as “uplink” in terms of the direction of the connection (S15). Then the CPU 0 performs the processing in S23.

When the connection information matching the transmission related information obtained in S12 is not recorded in the connection information table 43 (“No” in S14), the CPU 0 executes the following processing. That is to say, the CPU 0 replaces the contents of the “transmission destination IP address” of transmission related information with the contents of the “transmission source IP address”, and replaces the contents of the “transmission destination port number” with the contents of the “transmission source port number” (S16). In the following, the transmission related information replaced in S16 is referred to as “replaced transmission related information”.

The CPU 0 searches the connection information table 43 by using the replaced transmission related information. Thereby, the CPU 0 determines whether a connection is established, and further detects the packet transmission direction (S17). Specifically, the CPU 0 determines whether the connection information matching the replaced transmission related information is recorded in the connection information table 43 or not.

When the connection information matching the replaced transmission related information is recorded in the connection information table 43 (“Yes” in S18), the CPU 0 identifies the received packet transmission direction as “downlink” in terms of the direction of the connection (S19). Then the CPU 0 performs the processing in S23.

When the connection information matching the replaced transmission related information is not recorded in the connection information table 43 (“No” in S18), the processing in S20 to S22 is performed as described above.

In this regard, hereinafter the transmission related information whose packet transmission direction is identified as “uplink”, and the replaced transmission related information whose packet transmission direction is identified as “downlink” is referred to as “target connection information”.

After the processing in S15 or S19, the CPU 0 determines whether a protocol corresponding to the connection information of the received packet is recorded in the distribution table 46 for each transmission direction (uplink or downlink) (S23).

When a protocol corresponding to the connection information of the received packet is recorded in the distribution table 46 (“Yes” in S23), the CPU 0 performs distribution processing (S30). A description will be given later of the distribution processing in S30.

When a protocol corresponding to the connection information of the received packet is not recorded in the distribution table 46 (“No” in S23), the CPU 0 continuously measures the reception interval of the received packet (S24). In order to measure the reception interval of a packet, the CPU 0 performs the following processing, for example. As described above, in the embodiment, it is assumed that the transmission interval of a packet is detected as a reception interval of the analyzer 11.

As a first example of measuring a reception interval of packets, the CPU 0 obtains time when receiving a packet by using a timer function or a clock circuit provided for the CPU 0. The CPU 0 reads a time at which an uplink packet or a downlink packet (hereinafter referred to as an uplink/downlink packet) was lastly received, from “uplink packet arrival time” 44e or “downlink packet arrival time” 44f in the packet management table 44. Then the CPU 0 calculates the difference between the read reception time at which an uplink/downlink packet was lastly received, and the reception time at which an uplink/downlink packet has been received this time as a reception interval. Then the CPU 0 updates the “uplink packet arrival time” 44e or the “downlink packet arrival time” 44f in the packet management table 44 by the reception time at which the uplink/downlink packet has been received this time.

As a second example of measuring a reception interval of packets, the CPU 0 may count the reception interval of packets by using the counting function held by the CPU 0 or the counting function held by the clock circuit. For example, when a packet is received, the CPU 0 initializes the counter to 0, and counts an interval until the CPU 0 receives the next packet. The counted value may be used as the reception interval.

The CPU 0 compares the reception interval calculated in S24 with a threshold value T1, and determines whether the received packet is a beginning candidate of a message or not (S25). Here, the threshold value T1 is the threshold value on the transmission interval described with reference to FIG. 5, and is stored in the storage device 22 as the threshold value information 48. When the reception interval calculated in S24 is less than or equal to the threshold value T1, the CPU 0 determines that the received packet is within the message and is different from the packet of the beginning packet candidate (the second or after that). Also, when the reception interval calculated in S24 is longer than the threshold value T1, the CPU 0 determines that the received packet is the beginning packet candidate of the message.

In S25, when it is determined that the received packet is different from the beginning packet candidate (the second or after that) (“No” in S26), the CPU 0 detects the packet length of the received packet (S27).

When the received packet is an uplink packet, the CPU 0 adds the detected packet length to the “sum total of the uplink packet lengths” 44g in the packet management table 44. When the received packet is a downlink packet, the CPU 0 adds the detected packet length to the “sum total of the downlink packet lengths” 44h in the packet management table 44 (S28).

The CPU 0 stores a received packet into a corresponding buffer for each piece of connection information (S29).

In S25, when it is determined that the received packet is the beginning packet candidate (“Yes” in S26), the CPU 0 performs protocol recording and distribution processing on the immediately preceding message (S31). Here, the immediately preceding message represents a message formed by a group of packets from a first beginning packet detected previously to a packet received immediately before a second beginning packet detected this time. A detailed description will be given of the processing in S31 with reference to FIG. 21.

FIG. 21 illustrates an operational flowchart for protocol record and distribution processing (S31) of an immediately preceding message, according to the embodiment. The CPU 0 obtains the sum total of the packet lengths from the packet management table 44, that is to say, the message length of the immediately preceding message (S41). At this time, when the processing is performed as an uplink message, the “sum total of the uplink packet lengths” 44g is obtained as the message length of the immediately preceding message. When the processing is performed as a downlink message, the “sum total of the downlink packet lengths” 44h is obtained as the message length of the immediately preceding message.

The CPU 0 searches all the range of the message for a position at which the same value as the message length of the immediately preceding message held in the buffer, for example, from the beginning to the end. The CPU 0 stores information on the detected position (an address of a message-length storing area in which the message length is stored and a size of the message-length storing area, where the address is indicated by the number of bytes from the beginning of the message) into the storage position detection frequency table 47 as a result of the search. Also, when the already searched position is recorded in the storage position detection frequency table 47, the CPU 0 adds one to the number of times of detection corresponding to the position (S42).

The CPU 0 obtains position information for the detected position (the address and the size of the message-length storing area) having the largest number of times of detection (the mode value) and the total number of detected messages, from the storage position detection frequency table 47 (S43).

The CPU 0 obtains the protocol name corresponding to the obtained position information having the mode value, from the message position definition table 45 (S44).

The CPU 0 determines whether the total number of messages, obtained in S43, is less than a threshold value T2 or not (S45). The threshold value T2 is recorded in the storage device 22 as one piece of threshold value information 48. When the total number of the messages is less than the threshold value T2 (“Yes” in S45), the processing proceeds to S47. When the total number of the messages is the threshold value T2 or more (“No” in S45), the CPU 0 records the connection destination IP address, the connection destination port number of the message, and the protocol name obtained in S44 (S46) in the distribution table 46.

The CPU 0 gets a group of packets (a message) from the buffer (S47), and distributes the message to each message analysis processing in accordance with the protocol of the message (S48). The distributed messages are subjected to analysis processing (S49).

When an analysis error is detected in the message analysis processing (“No” in S50), the CPU 0 executes initialization processing (S51). Here, the CPU 0 deletes the recorded protocol and the information on the message corresponding to the protocol from the distribution table 46 and the storage position detection frequency table 47.

FIG. 22 illustrates an operational flowchart for distribution processing (S30) of a packet whose protocol is recorded, according to the embodiment. When a protocol corresponding to the connection is recorded in the distribution table 46 (“Yes” in S23), the CPU 0 stores the received packet into a buffer corresponding to the connection (S61). The CPU 0 obtains position information indicating an address and a size of the message-length storing area corresponding to the protocol name, from the message position definition table 45 (S62).

The CPU 0 obtains the “sum total uplink packet lengths” 44g or the “sum total of downlink packet lengths” 44h from the packet management table 44 (S63).

The CPU 0 compares the message length obtained using the message position definition table 45, with the sum value of the sum total of the packet lengths obtained from the packet management table 44 and the packet length of the packet received this time (the sum total of the packet lengths of the received packets) (S64). When the sum total of the packet lengths of the received packets has not reached the message length (“No” in S65), the CPU 0 performs the following processing. That is to say, the CPU 0 adds the packet length of the packets received this time to the “sum total of the uplink packet lengths” 44g or the “sum total of the downlink packet lengths” 44h of the packet management table 44 (S72), and this processing flow is terminated.

When the sum total of packet lengths of the received packets reaches the message length (“Yes” in S65), the CPU 0 performs the following processing. That is to say, the CPU 0 initializes the “sum total of uplink packet lengths” 44g or the “sum total of downlink packet lengths” 44h in the packet management table 44 (S66).

The CPU 0 gets a group of packets (a message) from the buffer (S67), and distributes the message to the message analysis processing in accordance with the protocol of the message (S68). The distributed message is subject to the analysis processing (S69).

When an analysis error is detected in the message analysis processing (“No” in S70), the CPU 0 executes the initialization processing (S71). Here, the CPU 0 deletes the recorded protocol and information on the message corresponding to the protocol, from the distribution table 46 and the storage position detection frequency table 47.

With the embodiment, a position at which the same value as the length of the message identified by the packet reception interval is stored is estimated by the detection frequency, and a group of packets received until reaching to the message length stored in the estimated position is detected as one message. Thereby, the message identification precision is improved.

That is to say, even if the communication protocol type of a received packet is unknown, it is possible to estimate the storage position of a message length from the received packet by using the message length obtained from the reception interval of packets, and to identify a protocol from the estimated storage position. When the communication protocol of the connection information of the received packet is identified, it is possible to identify one message from the received packets not by using the message interval, but by using the message length.

In this regard, the present disclosure is not limited to the embodiments described above, and it is possible to employ various configurations or embodiments without departing from the spirit and scope of the present disclosure.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory, computer-readable recording medium having stored therein a packet analysis program for causing a computer to execute a process comprising:
extracting a group of packets, each of which has an identical transmission source address or an identical transmission destination address and is transmitted in an identical connection, based on data captured from packets transmitted between communication apparatuses;
identifying a first beginning-packet candidate and a second beginning-packet candidate, which are transmitted within the identical connection, based on a time difference of timings of capturing individual packets included in the extracted group of packets;
calculating a message length from packet lengths of packets including the first beginning packet candidate, captured before capturing the second beginning-packet candidate and after capturing the first beginning-packet candidate;
estimating a position at which a message length of a message formed by the group of packets is stored, from the first beginning-packet candidate, based on the calculated message length; and
detecting the message formed by the extracted group of packets in accordance with the message length stored at the estimated position.

2. The non-transitory, computer-readable recording medium of claim 1, wherein
the estimating the position includes:
searching, for each message, the first beginning-packet candidate for positions at which a value identical to the message length is stored,
measuring, for each of the positions, a number of times of detection of the each position, and
determining a position for which the measuring is performed a largest number of times, to be a position at which the message length of the message formed by the group of packets is stored.

3. The non-transitory, computer-readable recording medium of claim 1, wherein
the detecting the message includes:
obtaining the message length from a received packet, based on the determined position,
holding received packets sequentially, and
determining a group of the held packets to be one message when a sum total of packet lengths of the held packets reaches the message length.

4. The non-transitory, computer-readable recording medium of claim 1, wherein the process further comprises:
upon the position being estimated, obtaining a communication protocol corresponding to the estimated position from information associating a communication protocol with a message-length storing position, and identifying a communication protocol corresponding to a connection of the message to be the obtained communication protocol; and
in the detecting the message, when packets are received and the communication protocol corresponding to the connection of the received packets is identified, obtaining a message length from the received packets, based on the estimated position, holding the received packets sequentially, and when a sum total of packet lengths of the held packets reaches the message length, determining a group of the held packets to be one message.

5. A packet analysis method for causing a computer to perform a process comprising:
extracting a group of packets, each of which has an identical transmission source address or an identical transmission destination address and is transmitted in an identical connection, based on data captured from packets transmitted between communication apparatuses;
identifying a first beginning-packet candidate and a second beginning-packet candidate, which are transmitted within the identical connection, based on a time difference of timings of capturing individual packets included in the extracted group of packets;
calculating a message length from packet lengths of packets including the first beginning packet candidate, captured before capturing the second beginning-packet candidate and after capturing the first beginning-packet candidate;
estimating a position at which a message length of a message formed by the group of packets is stored, from the first beginning-packet candidate, based on the calculated message length; and
detecting the message formed by the extracted group of packets in accordance with the message length stored at the estimated position.
